(19) United States
(12) Patent Application Publication
(10) Pub. No.: US 2013/0055350 A1
(43) Pub. Date: Feb. 28, 2013

(54) Creating Incentives By Controlling Device Functions

(71) Applicant: Sean Belanger, Largo, FL (US)

(72) Inventor: Sean Belanger, Largo, FL (US)

(73) Assignee: Only1Question.com Inc., Largo, FL (US)

(21) Appl. No.: 13/599,039

(22) Filed: Aug. 30, 2012

Related U.S. Application Data
(60) Provisional application No. 61/528,952, filed on Aug. 30, 2011.

(51) Int. Cl. G06F 21/00

(52) U.S. Cl. 726/3

(57) ABSTRACT

Disclosed are various embodiments for systems, methods, and apparatus for controlling functions in a client device to thereby create incentives for the user of the client device. In one embodiment, a function of the device is controlled and a prompt is displayed on a user interface. A user then provides an answer to the prompt. If the answer is correct, for example, normal function of the device is returned.

### CROSS-REFERENCE TO RELATED APPLICATION

This application claims priority to copending U.S. provisional application entitled, “Creating Incentives by Controlling Device Function,” having Ser. No. 61/528,952, filed Aug. 30, 2011, which is incorporated herein by reference herein in its entirety.

### BACKGROUND

Consumer devices, such as personal computers, smartphones, music players, and game devices may have the ability to access the internet, make calls, and send messages to other devices. For many users, the functionality of these devices has become an important tool for productivity and entertainment.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of networked environment according to various embodiments of the present disclosure.

FIG. 2 is a flowchart illustrating one example of functionality implemented as portions of a function controller executed in a client in the networked environment of FIG. 1 according to various embodiments of the present disclosure.

FIG. 3 is a drawing of a networked environment according to other embodiments of the present disclosure.

FIG. 4 is a flowchart illustrating another example of functionality implemented as portions of a function controller executed in a client in the networked environment of FIG. 3 according to various embodiments of the present disclosure.

FIG. 5 is a flowchart illustrating an example of functionality implemented as portions of a client device controller engine executed in at least one server in the networked environment of FIG. 3 according to various embodiments of the present disclosure.

FIG. 6 is a schematic block diagram that provides one example illustration of a server employed in the networked environment of FIGS. 1 and 3 according to various embodiments of the present disclosure.

FIG. 7 is a schematic block diagram that provides one example illustration of a client employed in the networked environment of FIGS. 1 and 3 according to various embodiments of the present disclosure.

### DETAILED DESCRIPTION

The present disclosure relates to creating incentives by controlling functions of a client. A non-limiting example follows. A client device obtains a prompt and a key from a server. The client device waits for an event, and a function controller causes specified functions of the client to become temporarily unavailable. The prompt is also displayed on a user interface of the client device, and the client device waits for a user to input an answer to the prompt. For example, the prompt may be “Who is the Vice President of the United States?” with the key being “Joe Biden.” The specified functions of the client device remain unavailable until a user enters an answer to the prompt. If the answer matches the key, the function controller restores the functions that were previously unavailable. Thus, by limiting functions of the client device, the function controller creates an incentive for the user of the client device to learn the key.

Another non-limiting example follows. The client device obtains a prompt and key from a server. The client device waits for a specified time or event, and the function controller monitors for activity on the client device. Upon the specified activity of the client becoming active or inactive, the function controller causes the prompt to be displayed on the user interface of the client device. The user may clear the prompt, but the prompt reappears upon the specified activity again becoming active or inactive. In order to stop the prompt from reappearing, the user may enter an answer to the prompt. If the answer matches the key, the function controller stops the prompt from reappearing. Thus, by creating nuisance functions, the function controller creates an incentive for the user of the client device to learn the key.

In a further non-limiting example, an administrator device causes the server to send an instruction to the function controller in the client device to create nuisance functions or cause specified functions to become temporarily unavailable. A prompt may be displayed, and the functions are controlled until an administrator device authorizes the functions to be restored. For example, the prompt may be “Go clean your room.” When the administrator wishes to restore normal operation of the client device, the administrator device sends an authorization command to the server, and the server sends an instruction to the function controller to restore the functions of the client device. In the following discussion, a general description of the system and its components is provided, followed by a discussion of the operation of the same.

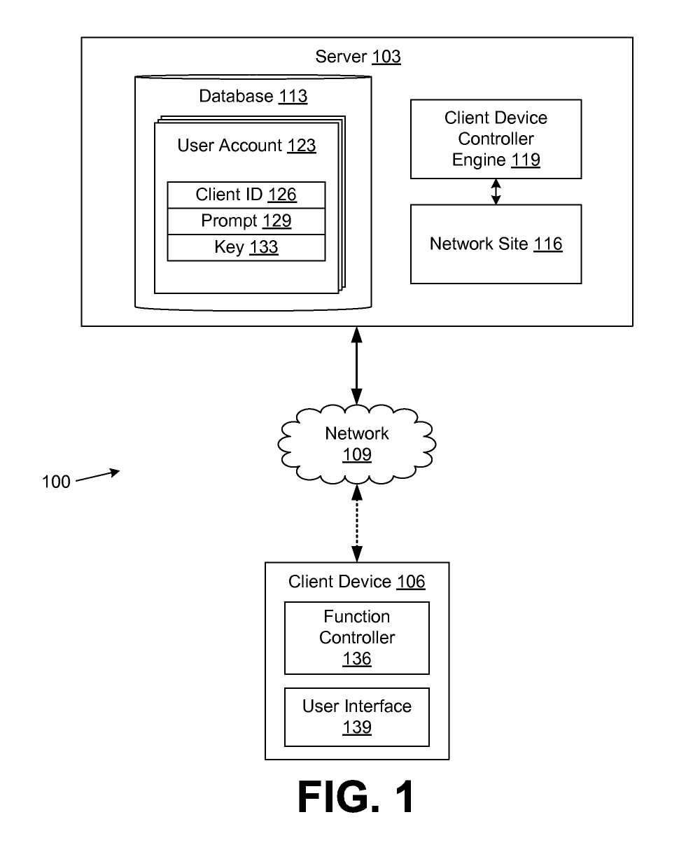

With reference to FIG. 1, shown is an example, among others, of a network environment 100 according to a first embodiment of the present disclosure. The network environment 100 includes a server 103 and a client device 106 in data communication via a network 109. The network 109 includes, for example, the Internet, intranets, extranets, wide area networks (WANs), local area networks (LANs), wired networks, wireless networks, or other suitable networks, or any combination thereof.

The server 103 may comprise, for example, a server computer or any other system providing computing capability. Alternatively, a plurality of servers 103 may be employed that are arranged, for example, in one or more server banks or computer banks or other arrangements. For example, a plurality of servers 103 together may comprise a cloud computing resource, a grid computing resource, and/or any other distributed computing arrangement. Such servers 103 may be located in a single installation or may be distributed among many different geographical locations. For purposes of convenience, the server 103 is referred to herein in the singular. Even though the server is referred to in the singular, it is understood that a plurality of servers 103 may be employed in the various arrangements as described above.

Various applications and/or other functionality may be executed in the server 103 according to various embodiments. Also, various data may be stored in a database 113 that is accessible to the server 103. The database 113 may be representative of a plurality of databases as can be appreciated. The data stored in the database 113, for example, is associated with the operation of the various applications and/or functional entities described below.

The components executed on the server 103, for example, may include a network site 116, a client device controller engine 119, and potentially other applications, services, processes, systems, engines, or functionality not discussed in detail herein. The client device controller engine 119 is executed to facilitate controlling and restoring functions of the client device 106. To this end, the client device controller engine 119 may generate and send instructions or commands to the client device 106 that are associated with controlling and restoring functions of the client device 106.

The network site 116 may provide a network presence, such as a web site, for the client device 106 and other devices to access the client device controller engine 119. To this end, the network site 116 may include a network page server to serve data such as network pages to the client device 106 over a protocol such as hypertext transfer protocol (HTTP), simple object access protocol (SOAP), and/or other protocols. Such a network page server may comprise a commercially available network page server such as, for example, Apache® HTTP Server, Microsoft® Internet Information Services (IIS), and/or other network page servers.

The data stored in the database 113 includes, for example, a listing of user accounts 123 and potentially other data. Upon a user registering for service with the client device controller engine 119, a user account 123 may be created and associated with the user. Associated with each user account 123 may be data representing a client identifier 126, a prompt 129, a key 133, and various other data created and collected throughout the operation of the client device controller engine 119.

The client identifier 126 facilitates identifying the client device 106 that is associated with a specific user account 123 among other client devices 106 that are associated with other user accounts 123. The client identifier 126 may be, for example, a telephone number, email address, user name, or other any other identifier that may be used to associate a client device 106 with a specific user account 123. The prompt 129 may be a statement, question, alert, sound, vibration, alarm or any other stimulus that may be sent to the client device 106 or triggered in the client device 106. The prompt and its content may be generated by the client device controller engine 119, a user, the client device 106, or any other device or application. The key 133 may be an answer to a question, a pass code, etc., and is used to initiate restoring normal function to the client device 106 or terminating nuisances, as discussed below. Keys 133 may be generated by the client device controller engine 119 or any other device, but are typically unknown to the user of the client device 106 prior to the prompt 129 being activated in the client device 106.

The client device 106 is representative of a plurality of client devices 106 that may be coupled to the network 109. The client device 106 may comprise, for example, a processor-based system such as a computer system. Such a computer system may be embodied in the form of a desktop computer, a laptop computer, a personal digital assistant, a cellular telephone, a set-top box, a music player, a web pad, a tablet computer system, a game console, an electronic book reader, a smartphone, or other type of device with like capability.

The client device 106 may be configured to execute various applications such as a function controller 136 and/or other applications such as email applications, instant message applications, and/or other applications. The function controller 136 may receive prompts 129, keys 133, commands, and other data from the client device controller engine 119. The function controller 136 may temporarily control specified functions of the client device 106. Additionally, the function controller 136 may restore normal functionality of the functions that had been controlled by the function controller 136. Furthermore, the function controller 136 may monitor activity on the client device 106 and activate a prompt 129 upon a specified activity becoming active or inactive.

The client device 106 may also provide a user interface 139 to facilitate a user interacting with and controlling the client device 106. To this end, the user interface 139 may present visual representations of information, functionality, control elements, etc. The user interface 139 may also provide auditory, tactile, or other types of alerts, such as chimes, vibrations, or other alerts that may be sensed by the user.

Next, a general description of the operation of the various components of the networked environment 100 is provided. To begin, it is assumed that the server 103 and client device 106 are powered up and populated with their respective data. Additionally, it is assumed that the client device controller engine 119 is running on the server 103 and that the function controller 136 is running on the client device 106.

First, a user of the client device 106 may initiate service with the client device controller engine 119. The user may initiate service, for example, by downloading and installing the function controller 136 on the client device 106. The user or client device 106 may provide various information relating to the user and/or client device 106 such as, for example, the client identifier 126, the time the user wishes for prompts to be activated, the specified functions that are to be controlled, and possibly other information.

After the user has initiated service with the client device controller engine 119 and the function controller 136 is installed on the client device 106, the function controller 136 may be executed. The function controller 136 may run, for example, as a background process or daemon so as to not interfere with the user experiencing and interacting with the client device 106 until desired to do so. While running on the client device 106, the function controller 136 may request a prompt 129 and key 133 from the client device controller engine. Alternatively, the client device controller engine 119 may send a prompt 129 and key 133 to the function controller 136 without being requested by the function controller 136.

After a prompt 129 and key 133 have been obtained by the client device 106, the function controller 136 may wait until a specified time to begin controlling one or more functions of the client device 106. At the specified time, the function controller 136 may control one or more specified features or functions of the client device 106. For example, if the client device 106 is a cellular telephone, the function controller 136 may prevent the user from sending or receiving text messages, executing applications that access the internet, or using any other function of the client. Additionally, the function controller 136 may limit or control the functions of other applications running on the client device 106. The function controller 136 may also prevent the user from executing all functions of the client device 106 with the exception of specified functions. As a non-limiting example, if the client device 106 is a cellular telephone, the function controller 136 may prevent the user from accessing all other applications on the client device 106, except for applications that facilitate making and receiving telephone calls.

The function controller 136 may also cause a prompt 129 to be displayed on the user interface 139 while the functions of the client device 106 are being controlled. For example, the function controller 136 may cause the prompt 129 that reads “Who is the Vice President of the United States?” to be displayed on the user interface 139. Another example of a prompt may be “Did you clean your room? Enter passcode:.”

The function controller 136 may also provide an input area on the user interface 139 for the user to enter an answer to the prompt 129. Upon the user entering an answer, the function controller 136 compares the answer to the key 133. If the answer is not identical or substantially similar to the key 133, the functions of the client device 106 may remain controlled and the prompt re-displayed as discussed above. If the answer is identical to the key 133, the function controller 136 restores the client device 106 functions that had been restricted. The function controller 136 may also take spelling and character case errors into account when determining whether an answer matches a key 133.

Instead of controlling functions of the client device 106, the function controller 136 may activate one or more specified functions of the client device 106. For example, the function controller 136 may monitor activity on the client device 106 and activate a specified function upon an activity becoming active or inactive. As a non-limiting example, the function controller 136 may detect the client device 106 being awoken from a sleep condition and cause a message with a prompt 129 to be displayed on the user interface 139. The message may be cleared by the user, but the message may reappear each time the client device 106 is awoken. The user may prevent the message from reappearing by entering an answer that matches the key 133, as discussed above. Thus, the function controller 136 may create various incentives for the user to learn the key 133.

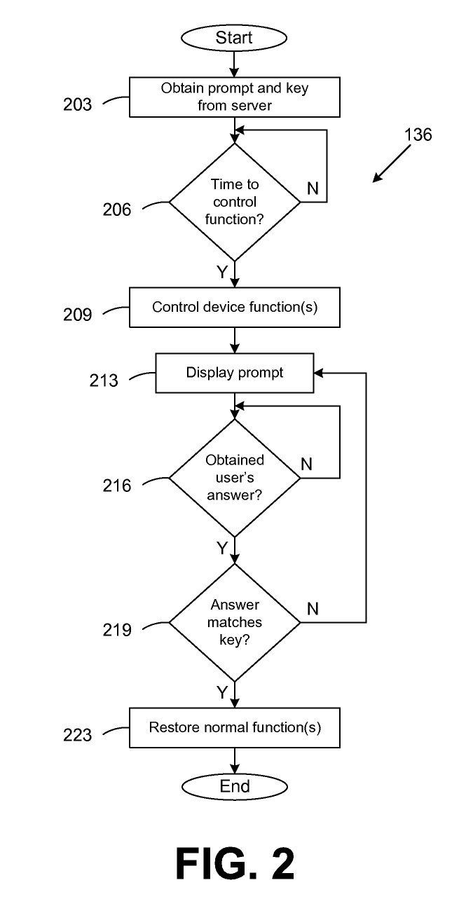

Referring next to FIG. 2, shown is a flowchart that provides one example of the operation of a portion of the function controller 136 according to various embodiments. It is understood that the flowchart of FIG. 2 provides merely an example of the many different types of functional arrangements that may be employed to implement the operation of the portion of the function controller 136 as described herein. As an alternative, the flowchart of FIG. 2 may be viewed as depicting an example of steps of a method implemented in the client device 106 (FIG. 1) according to one or more embodiments.

Beginning with box 203, the function controller 136 obtains the prompt 129 and key 133 from the server 103 (FIG. 1). In some embodiments, the function controller 136 may request the prompt 129 and key 133. As an alternative, the server 103 may send the prompt 129 and key 133 to the function controller 136 automatically without a request. After the prompt 129 and key 133 have been obtained by the client device 106, the function controller 136 waits until a specified time to control the client device 106 functions, as shown in box 206. The specified time may be the same time every day, for example, at noon. Alternatively, the specified time may be determined by a timer set by the function controller 136 or client device controller engine 119 (FIG. 1).

Moving to box 209, the function controller 136 begins to control the specified functions of the client device 106. For example, the function controller 136 may restrict specified functions and/or applications or cause nuisance functions to become activated, as discussed above. In some embodiments, the function controller 136 may slow functions or applications. For instance, the function controller 136 may cause web pages or text messages to render slowly. Alternatively, the function controller 136 may activate nuisance functions, such as an alarm, message, or vibration that activates periodically. After the specified functions of the client device 106 are being controlled, the function controller 136 causes the prompt 129 (FIG. 1) to be displayed on the user interface 139 (FIG. 1), as depicted in box 213. With the prompt 129 being displayed, the function controller 136 waits for the user to input an answer to the prompt, as shown in box 216.

After an answer has been obtained, the function controller 136 determines whether the answer matches the key 133, as depicted in box 219. If the answer does not match the key 133, the function controller 136 moves to box 213, displays the prompt 129, and proceeds as shown in the flowchart. Alternatively, if the answer and key 133 match, the function controller 136 returns normal operation to the functions that were being controlled, as depicted in box 223. Thereafter, the process ends.

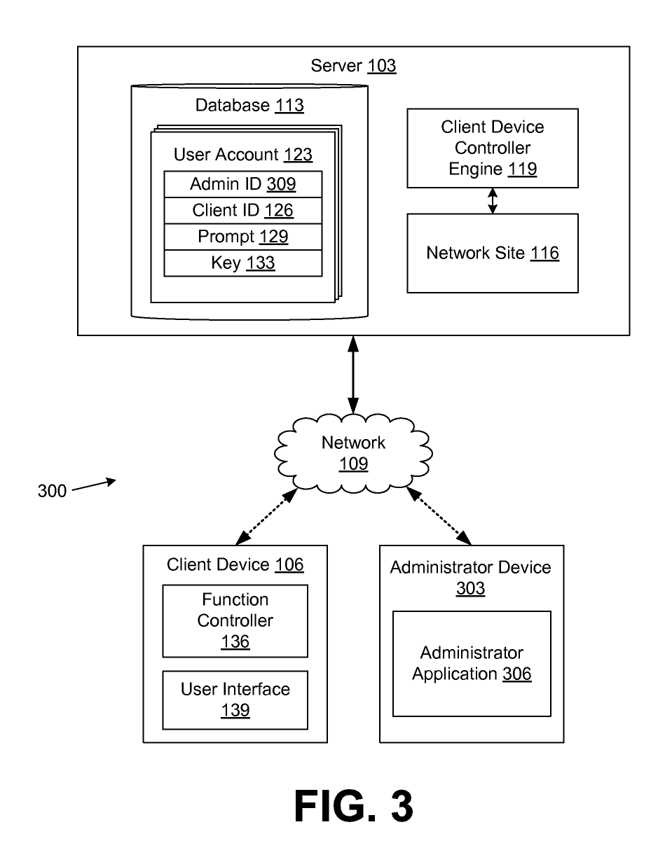

With reference to FIG. 3, shown is a network environment 300 according to a second embodiment. The network environment 300 includes the server 103, the client device 106, and the network 109 as described in the first embodiment above.

In addition, the network environment 300 now includes an administrator device 303. The administrator device 303 may comprise, for example, a processor-based system such as a computer system. Such a computer system may be embodied in the form of a desktop computer, a laptop computer, a personal digital assistant, a cellular telephone, a set-top box, a music player, a web pad, a tablet computer system, a game console, an electronic book reader, a smartphone, or other device with like capability. In general, the administrator device 303 is operated by a user that is in a supervisory position over the user that operates the client device 106. As a non-limiting example, the user of the administrator device 303 may be a parent of a child who operates the client device 106.

The administrator device may be configured to execute various applications such as an administrator application 306 and/or other applications, such as email applications, instant message applications, or other types of applications. The administrator application 306 may be executed in the administrator device 303, for example, to access the network site 116 or other network content. As such, the administrator application 306 may be embodied in the form of a web or network browser that accesses web or network pages. In alternative embodiments, the administrator application 306 may be embodied in the form of a stand-alone application that facilitates access the network site 116. The administrator device 303 may be configured to execute applications beyond the administrator application 306 such as, for example, email applications, instant message applications, and/or other applications.

The database 113 in the server 103 may include the listing of user accounts 123 comprising the client identifiers 126, prompts 129, and keys 133, similar to as described above. In addition, associated with each user account 123 may be one or more administrator identifiers 309. The administrator identifiers 309 facilitate identifying the administrator devices 303 associated with a specific user account 123. Each administrator identifier 309 may be, for example, a telephone number, email address, user name, or any other identifier that may be used to associate an administrator device 303 with a specific user account 123.

Next, a general description of the operation of the various components of the networked environment 300 is provided. To begin, it is assumed that the server 103, the client device 106, and the administrator device 303 are powered up and populated with their respective data. Additionally, it is assumed that the client device controller engine 119 is running on the server 103, that the function controller 136 is running on the client device 106, and that the administrator application 306 is running on the administrator device 303.

First, the client device 106 and administrator device 303 may initiate service with the client device controller engine 119. Service may be initiated, for example, by downloading and installing an application or by entering into a service agreement. Upon service initiation, a user account 123 may be created and associated with the administrator identifier 309 and client identifier 126 corresponding to the respective devices. After service is initiated, the function controller 136 may be installed on the client device 106 and executed as described in the first embodiment above.

While the function controller 136 is running on the client device 106, a user of the administrator device 303 may request that specified functions of the client device 106 be controlled. To this end, the administrator device 303 may access the network site 116, for example, by using the administrator application 306 logging on with a valid administrator identifier 309 and password or by any other authentication procedure. Thereafter, the administrator device 303 may request that functions of the client device 106 be controlled. Also, the administrator device 303 may identify specific functions that are to be controlled. As a non-limiting example, the administrator device 303 may request that the client device 106 be prohibited from sending text messages and accessing the internet. Alternatively, the administrator device 303 may request nuisance behavior to become activated. A user for the administrator device 303 may also specify a user-generated prompt 129. As an alternative, the prompt 129 may be generated by the client device controller engine 119. The administrator device 303 may also specify the time for the function of the client device 106 to be controlled. As a non-limiting example, the administrator device 303 may request that functions of the client device 106 be controlled at noon, and the prompt 129 is “Go clean your room.”

After the administrator device 303 has specified the prompt 129, time, the specific functions to be control, and/or possibly other information for controlling one or more functions of the client device 106, the client device controller engine 119 may send this information to the function controller 136. As an alternative, the function controller 136 may periodically contact the client device controller engine 119 to request or obtain the information. After obtaining this information, the function controller may wait until the specified time to begin controlling client device 106 functions.

At the specified time, the function controller 136 may control one or more specified functions or features of the client device 106, as described in the first embodiment above. The function controller 136 may also cause the prompt 129 to be displayed in the user interface 139. The function controller 136 may control functions of the client device 106 until the administrator device 303 causes the functions to revert to normal operation. To this end, the administrator device 303 may access the network site 116, as discussed above, and instruct the client device controller engine 119 to cause the functions of the client device 106 resume normal operation. Upon receiving the instruction from the administrator device 303, the client device controller engine 119 may send a command to the function controller 136 instructing the normal operation.

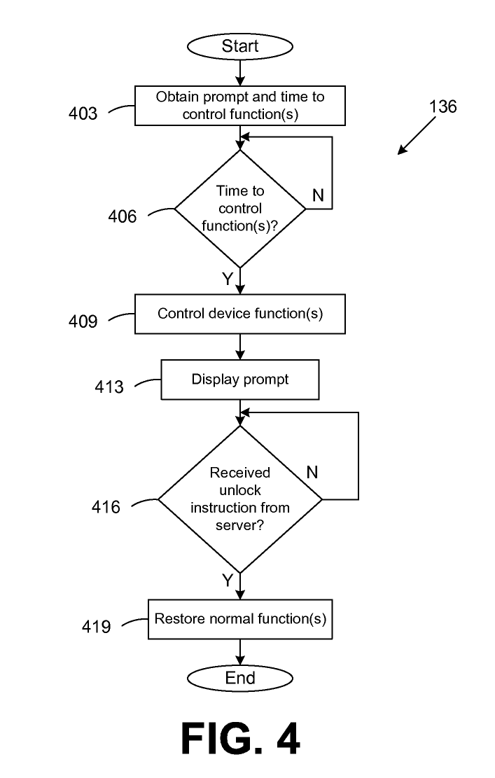

Referring next to FIG. 4, shown is a flowchart that provides one example, among others, of the operation of a portion of the function controller 136 according to various embodiments of the present disclosure. It is understood that the flowchart of FIG. 4 provides merely an example of the many different types of functional arrangements that may be employed to implement the operation of the portion of the function controller 136 as described herein. As an alternative, the flowchart of FIG. 4 may be viewed as depicting an example of steps of a method implemented in the client 106 (FIG. 3) according to one or more embodiments.

Beginning with box 403, the function controller 136 obtains data representing the prompt 129 (FIG. 3) and time to control the functions of the client device 106. The function controller 136 may request the data from the client device controller engine 119 (FIG. 3), or the client device controller engine 119 may send the data once the administrator device 303 (FIG. 3) has provided the relevant information. After the data have been obtained, the function controller 136 waits for a specified time to control the client device 106 functions, as shown in box 406.

Moving to box 409, the function controller 136 begins to control the specified functions of the client device 106. For example, the function controller 136 may temporarily restrict, control, and/or slow specified functions or cause nuisance functions to become activated, as discussed above. After the specified functions of the client device 106 are being controlled, the function controller 136 causes the prompt 129 (FIG. 3) to be displayed on the user interface 139 (FIG. 3), as depicted in box 413. For example, the user interface 139 may display the prompt “Go clean your room.” With the prompt 129 being displayed, the function controller 136 waits to receive an unlock instruction from the server 103, as shown in box 416.

As depicted in box 419, after the function controller 136 has received the unlock instruction, the function controller 136 returns the functions that were being controlled to their normal operation. Thereafter, the process ends.

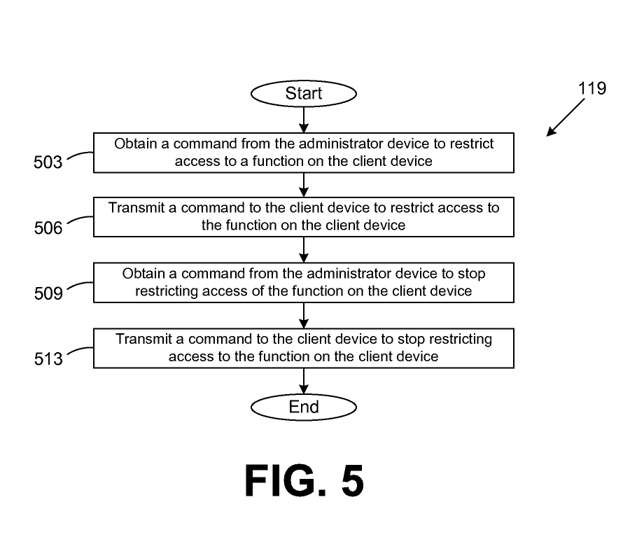

Referring next to FIG. 5, shown is a flowchart that provides one example, among others, of the operation of a portion of the client device controller engine 119 according to various embodiments of the present disclosure. It is understood that the flowchart of FIG. 5 provides merely an example of the many different types of functional arrangements that may be employed to implement the operation of the portion of the client device controller engine 119 as described herein. As an alternative, the flowchart of FIG. 5 may be viewed as depicting an example of steps of a method implemented in the server 103 (FIG. 3) according to one or more embodiments.

Beginning with box 503, the client device controller engine 119 obtains a command from the administrator device 303 (FIG. 3) to control or restrict access to a function on the client device 106 (FIG. 3). The function may be, for example, a text messaging service, an electronic mail service, an internet access service, or any other type of service or application. In some embodiments, the client device controller engine 119 may also obtain the prompt 129 (FIG. 3) or other information in conjunction with the command from the administrator device 303. Next, the client device controller engine 119 transmits a command to the client device 106 to control or restrict access to the function on the client device 106, as shown in box 506. The client device controller engine 119 may also, for example, encode and transmit a prompt 129 for rendering on the user interface 139 (FIG. 3).

Later, in box 509, the client device controller engine 119 obtains a command from the administrator device 303 to stop controlling or restricting access of the function on the client device 106. The client device controller engine 119 then moves to box 513 and transmits a command to the client device 106 to stop controlling or restricting access to the function of the client device 106. Thereafter, the process ends.

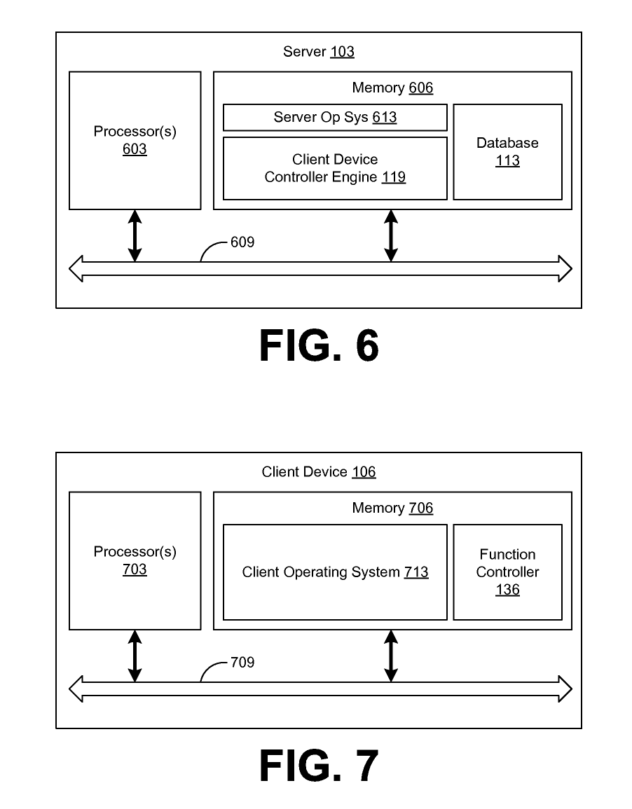

With reference to FIG. 6, shown is a schematic block diagram of the server 103 according to an embodiment of the present disclosure. The server 103 includes at least one processor circuit, for example, having a processor 603 and a memory 606, both of which are coupled to a local interface 609. The local interface 609 may comprise, for example, a data bus with an accompanying address/control bus or other bus structure as can be appreciated.

Stored in the memory 606 are both data and several components that are executable by the processor 603. In particular, stored in the memory 606 and executable by the processor 603 is the client device controller engine 119 and potentially other applications. Also stored in the memory 606 may be the database 113 and other data. In addition, an operating system 613 may be stored in the memory 606 and executable by the processor 603.

With reference to FIG. 7, shown is a schematic block diagram of the client device 106 according to an embodiment of the present disclosure. The client device 106 includes at least one processor circuit, for example, having a processor 703 and a memory 706, both of which are coupled to a local interface 709. The local interface 709 may comprise, for example, a data bus with an accompanying address/control bus or other bus structure as can be appreciated.

Stored in the memory 706 are both data and several components that are executable by the processor 703. In particular, stored in the memory 706 and executable by the processor 703 is the function controller 136 and potentially other applications. In addition, an operating system 713 may be stored in the memory 706 and executable by the processor 703.

It is understood that there may be other applications that are stored in the memories 606 and 706 and are executable by the processors 603 and 703, respectively, as can be appreciated. Where any component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages.

A number of software components are stored in the memories 606 and 706 and are executable by the processors 603 and 603, respectively. In this respect, the term “executable” means a program file that is in a form that can ultimately be run by the processors 603 and 703. Examples of executable programs may be, for example, a compiled program that can be translated into machine code in a format that can be loaded into a random access portion of the memories 606 and 706 and run by the processors 603 and 703, respectively, source code that may be expressed in proper format such as object code that is capable of being loaded into a random access portion of the memories 606 and 706 and executed by the processors 603 and 703, respectively, or source code that may be interpreted by another executable program to generate instructions in a random access portion of the memories 606 and 706 to be executed by the processors 603 and 703, respectively, etc. An executable program may be stored in any portion or component of the memories 606 and 706 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memories 606 and 706 are defined herein as including both volatile and nonvolatile memory and data storage components. Volatile components are those that do not retain data values upon loss of power. Nonvolatile components are those that retain data upon a loss of power. Thus, the memory 606 and 706 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, each processor 603 and 703 may represent multiple processors 603 and 703 and each memory 606 and 706 may represent multiple memories 606 and 706 that operate in parallel processing circuits, respectively. In such a case, the local interfaces 609 and 709 may be an appropriate network 100 and 300 (FIGS. 1 and 3) that facilitates communication between any two of the multiple processors 603 and 703, between any processor 603 and 703 and any of the memories 606 and 706, or between any two of the memories 606 and 706, etc. The local interfaces 609 and 709 may comprise additional systems designed to coordinate this communication, including, for example, performing load balancing. The processors 603 and 703 may be of electrical or of some other available construction.

Although the client device controller engine 119, function controller 136, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowcharts of FIGS. 2 and 4-5 show the functionality and operation of an implementation of portions of the client device controller engine 119 and function controller 136. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 603 and 703 in a computer system or other system. The machine code may be converted from the source code, etc. If embodied in hardware, each block may represent a circuit or a number of interconnected circuits to implement the specified logical function(s).

Although the flowcharts of FIGS. 2 and 4-5 show a specific order of execution, it is understood that the order of execution may differ from that which is depicted. For example, the order of execution of two or more blocks may be scrambled relative to the order shown. Also, two or more blocks shown in succession in FIGS. 2 and 4-5 may be executed concurrently or with partial concurrence. Further, in some embodiments, one or more of the blocks shown in FIGS. 2 and 4-5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the client device controller engine 119 and function controller 136, that comprises software or code can be embodied in any non-transitory computer-readable medium for use by or in connection with an instruction execution system such as, for example, a processor 603 and 703 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It is emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure.

Therefore, at least the following is claimed:

1. A system, comprising:
at least one server; and
a client device controller engine executable in the at least one server, the client device controller engine comprising:
logic that obtains, from an administrator device, a first command to restrict a user access to a function on client device to serve as an incentive for a user of the client device to perform an activity, the function comprising at least one of:
a text messaging service;
an electronic mail service; or
an internet access service;
logic that, in response to obtaining the first command, transmits a second command to the client device to initiate restricting the user access to the function on the client device;
logic that obtains, from the administrator device, a third command to stop restricting the user access of the function on the client device; and
logic that, in response to obtaining the third command, transmits a fourth command to the client device to stop restricting the user access to the function on the client device.

2. The system of claim 1, wherein the client device controller engine further comprises:
logic that obtains a prompt from the administrator device;
logic that encodes the prompt for rendering on a user interface of the client device; and
logic that transmits the prompt to the client device.

3. The system of claim 1, wherein the client device controller engine further comprises:
logic that obtains, from the administrator device, a specified time to restrict the user access to the function on the client device; and
logic that causes the user access to the function on the client device to be restricted at the specified time.

4. A method, comprising the steps of:
initiating, in a client device, control of a function of the client device in response to an occurrence of a predetermined event;
displaying, in a user interface for the client device, a rendering of a prompt in response to the occurrence of the predetermined event;
obtaining, in the client device, an answer to the prompt from a user of the client device; and
determining whether to stop or permit controlling the function of the client device based at least in part on the answer.

5. The method of claim 4, wherein the step of controlling the function of the client device comprises preventing access to the function on the client device.

6. The method of claim 4, wherein the step of controlling the function of the client device comprises slowing the function on the client device.

7. The method of claim 5, wherein the function comprises at least one of a text messaging service, an electronic mail service, or an internet access service.

8. The method of claim 4, wherein the predetermined event comprises at least one of being a specified time or receiving a specified command from at least one server.

9. The method of claim 4, further comprising the step of obtaining the prompt from at least one server.

10. The method of claim 9, wherein the prompt from the server is based at least in part on data provided by an administrator device that is in communication with the server.

11. The method of claim 4, further comprising the step of obtaining the prompt and a key from at least one server;
wherein the step of determining whether to stop controlling the function of the client device is further based at least in part on whether the answer from the user matches the key from the server.

12. The method of claim 11, wherein the prompt and the key from the server are provided by another user of an administrator device that is in communication with the server.

13. A method, comprising the steps of:
initiating, in a client device, a nuisance function on the client device in response to an occurrence of a predetermined event, the nuisance function being an incentive for a user of the client device to perform an activity;
displaying, in a user interface for the client device, a rendering of a prompt in response to the occurrence of the predetermined event; and
determining, in the client device, whether to stop or permit the nuisance function on the client device based at least in part on data obtained by the client device.

14. The method of claim 13, wherein the nuisance function comprises periodically displaying the prompt on the user interface for the client device.

15. The method of claim 13, wherein the nuisance function comprises periodically producing an audible alert from the client device.

16. The method of claim 13, wherein the nuisance function comprises periodically vibrating the client device.

17. The method of claim 13, further comprising the step of obtaining, in the client device, an answer to the prompt from the user of the client device;
wherein the step of determining whether to stop the nuisance function is further based at least in part on the answer to the prompt obtained from the user.

18. The method of claim 13, wherein the step of determining whether to stop the nuisance function on the client device is based at least in part on data obtained by the client device from at least one server, the data being based at least in part on an instruction from an administrator device to stop the nuisance function.

19. The method of claim 13, wherein the predetermined event comprises being a specified time.

20. The method of claim 13, wherein the predetermined event comprises receiving a specified command from at least one server.
